(19) United States
(12) Patent Application Publication
(10) Pub. No.: US 2023/0051632 A1
(43) Pub. Date: Feb. 16, 2023

(54) SYSTEMS AND METHODS FOR AN AUTONOMOUS VEHICLE

(71) Applicant: TUSIMPLE, INC., San Diego, CA (US)

(72) Inventors: Niranjan Shenoy Bellare, Canton, MI (US); Ali Reza Abbaspour, San Diego, CA (US); Ali Mohamad Houry, Dearborn, MI (US); Ravindranath Kallalli Hanumanthappa, Rochester Hills, MI (US)

(21) Appl. No.: 17/819,549

(22) Filed: Aug. 12, 2022

Related U.S. Application Data
(60) Provisional application No. 63/233,108, filed on Aug. 13, 2021.

(51) Int. Cl. B60W 60/00; B60W 30/16; B60W 40/02; B60W 40/105; B60W 40/13; B60Q 9/00

(52) U.S. Cl. CPC B60W 60/0011; B60W 60/0015; B60W 30/16; B60W 40/02; B60W 40/105; B60W 40/13; B60Q 9/008; B60W 2300/14; B60W 2530/10; B60W 2554/4041; B60W 2554/802

(57) ABSTRACT

A method of operating an autonomous vehicle includes determining, by the autonomous vehicle, whether a target is in an intended maneuver zone around the autonomous vehicle; generating, by the autonomous vehicle, a signal in response to determining that the target is within the intended maneuver zone around the autonomous vehicle; determining, by the autonomous vehicle and based on perception information acquired by the autonomous vehicle, whether the target has left the intended maneuver zone around the autonomous vehicle; and determining, by the autonomous vehicle, that it is safe to perform the intended maneuver in response to determining, by the autonomous vehicle, that the target is not in the intended maneuver zone or in response to determining, by the autonomous vehicle, that the target has left the intended maneuver zone.

### PRIORITY CLAIMS AND RELATED PATENT APPLICATIONS

This patent document claims the priority to and the benefits of U.S. Provisional Application No. 63/233,108 entitled “SYSTEM AND METHOD FOR AN AUTONOMOUS VEHICLE” filed on Aug. 13, 2021. The entire disclosure of the aforementioned application is hereby incorporated by reference as part of the disclosure of this application.

### TECHNICAL FIELD

This document relates to autonomous driving systems. In particular, described herein are systems and methods for providing visual alerts to vehicles following an autonomous vehicle as well as to other road users sharing environment with the autonomous vehicle.

### BACKGROUND

Self-driving or autonomous vehicles can be autonomously controlled to navigate along a path to a destination. Autonomous driving generally requires sensors and processing systems that take in the environment surrounding an autonomous vehicle and make decisions that ensure the safety of the autonomous vehicle and surrounding vehicles as well as other objects, both moving and stationary, around the autonomous vehicle. For example, these sensors include cameras and light detection and ranging (LiDAR) sensors that use light pulses to measure distances to various objects surrounding the autonomous vehicle.

### SUMMARY

Systems and methods described herein include features allowing an autonomous vehicle to create visual or audio signals for vehicles around the autonomous vehicle, e.g., those vehicles that are tailgating the autonomous vehicle or are in a blind spot of the autonomous vehicle such that maneuvers of the autonomous vehicle might affect their safety.

The above and other aspects and features of the disclosed technology are described in greater detail in the drawings, the description, and the claims.

### BRIEF DESCRIPTION OF THE DRAWINGS

FIG. 1 illustrates a schematic diagram of a system including an autonomous vehicle, according to the disclosed technology.

FIG. 2 illustrates an example traffic scenario, according to the disclosed technology.

FIG. 3A illustrates another example traffic scenario, according to the disclosed technology.

FIG. 3B illustrates another example traffic scenario, according to the disclosed technology.

FIG. 3C illustrates examples of intention indicators, according to the disclosed technology.

FIG. 4 shows a flowchart of an example method, according to the disclosed technology.

### DETAILED DESCRIPTION

Autonomous driving systems (also referred to as autonomous driving vehicles or autonomous vehicles) should safely accommodate all types of road configurations and conditions, including weather conditions (e.g., rain, snow, wind, dust storms, etc.), traffic conditions, and behaviors of other road users (e.g., vehicles, pedestrians, construction activities, etc.). Autonomous driving systems should make decisions about the speed and distance of traffic as well as about obstacles, including obstacles that obstruct the view of the autonomous vehicle's sensors. For example, an autonomous vehicle should estimate the distances between it and other vehicles, as well as the speeds and/or accelerations of those vehicles (e.g., relative to the autonomous vehicle and/or relative to each other; vehicle speed or acceleration can be determined in a certain system of coordinates, for example). Based on that information, the autonomous vehicle can decide whether or not it is safe to proceed along a planned path, when it is safe to proceed, and it also can make corrections to the planned path, if necessary. In various embodiments, speeds or velocities are determined and locations of objects or distances to the objects are determined. For simplicity, the following description uses speed, but velocity could also be determined, where velocity is a speed and a direction (is a vector). Also, although distance is used below, location (e.g., in a 2D or a 3D coordinate system) can be used as well.

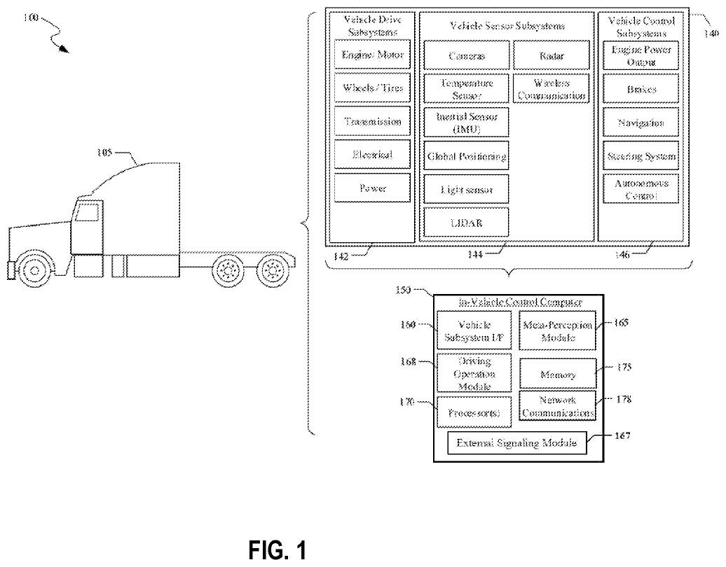

Examples of road configurations where these determinations and decisions should be made include so-called “T” intersections, so-called “Y” intersections, unprotected left turns, intersections with a yield where an autonomous vehicle (e.g., an autonomous truck) does not have the right-of-way, a roundabout, an intersection with stop signs where all traffic has to stop, and an intersection with 4 road sections and two stop signs where the autonomous vehicle must stop and other vehicles are not required to stop (e.g., cross-traffic does not stop), as well as many other road configurations. Examples of traffic conditions can include a vehicle tailgating the autonomous vehicle at a distance from the autonomous vehicle that the autonomous vehicle determines to be unsafe or potentially unsafe. For example, an autonomous vehicle may determine that a distance is unsafe if the distance is below a threshold value, which may be a predetermined distance value or a distance value determined by the autonomous vehicle based on traffic conditions, road conditions, speed of the vehicle following the autonomous vehicle relative to the speed of the autonomous vehicle, and/or a weight of the autonomous vehicle including the weight of goods (e.g., lumber, cars, furniture, corn, etc.) loaded in/on a trailer coupled to and transported by the autonomous vehicle. In some examples, the weight of the load and the trailer being transported/hauled by an autonomous vehicle can impact the performance of the autonomous vehicle. For example, an engine/motor of the vehicle drive subsystems 142 of FIG. 1, may have to generate more torque/power to move the load and the trailer compared to when there is no load and/or trailer transported by an autonomous tractor/vehicle 105. The autonomous tractor 105 may be referred to as an autonomous vehicle, an autonomous truck, or the like vehicle that may operate autonomously, semi autonomously, or by a human operator in the autonomous tractor 105 or from a remote location. In another example, the brakes in the vehicle control subsystems 146 of FIG. 1, may have to be applied with greater force and/or for a longer period of time when the autonomous tractor 105 is transporting the load and/or the trailer.

For all of the foregoing road configurations and traffic conditions, the autonomous vehicle must decide how it can safely proceed. To increase safety of the autonomous vehicle operation, the autonomous vehicle can provide visual and/or audio indications to other users on the road to help them to ensure to stay a safe distance from the autonomous vehicle, for example. According to some example embodiments, because of a non-compliant driver (e.g., a driver that drives erratically between the lanes) ahead of the autonomous vehicle, the autonomous vehicle might anticipate that it will need to apply its brakes suddenly or perform another sudden or aggressive maneuver at some point along its projected path. In such a situation, the autonomous vehicle can present a visual sign or signs on one or more locations on its body (e.g., back and/or sides) that alert other vehicles around it (e.g., that alert drivers of those vehicles) that the autonomous vehicle anticipates an upcoming situation where it might need to perform an aggressive/sudden maneuver (e.g., a sudden braking, an aggressive lane change, an aggressive acceleration, an aggressive deceleration, etc.) that can affect those vehicles. The visual sign can, for example, stay on until the potentially dangerous situation is eliminated, as determined by the autonomous vehicle. According to some example embodiments, the autonomous vehicle can also present visual signs to other vehicles indicating that they are in a spot with limited sensor reception by the autonomous vehicle (e.g., a “blind spot”) or that they are about to move into an area (e.g., sides or behind) around the autonomous vehicle where sensor perception of the autonomous vehicle is limited. Some implementations can provide signaling of the autonomous vehicle's intent via, e.g., an external visual indicator of what the autonomous vehicle's intent is (e.g., whether the vehicle is about to brake, change lanes, or perform some other maneuver).

Also, according to some example embodiments, when the autonomous vehicle is stopped at a traffic stop near a pedestrian crossing, it can generate visual and/or audio signals to acknowledge a pedestrian crossing the street along the pedestrian crossing (by, e.g., playing a pre-recorded message announcing that the autonomous vehicle is aware of the pedestrian's presence). Additionally, based on sensor data from sensors (e.g., scanning forward and rearward for other vehicles) on/in the AV, the AV may indicate to pedestrians that are on a sidewalk awaiting to cross the street that it may be safe to cross the street. For example, the AV may play a pre-recorded message announcing that those pedestrians can proceed crossing the street.

According to some example embodiments, an autonomous vehicle can display a sign for a tailgating vehicle indicating that the tailgating vehicle is too close to the autonomous vehicle. In some example embodiments, the sign can include a message indicating a distance at which it would be considered safe for other vehicles to follow the autonomous vehicle. Because the autonomous vehicle can typically obtain information about the surrounding environment a long distance ahead, it can instruct the vehicles following it (e.g., via displaying a visual sign for them) to keep at a safe distance from the autonomous vehicle. That safe distance can be determined by the autonomous vehicle based on, for example, information obtained by the autonomous vehicle from the surrounding environment using one or more sensors of the autonomous vehicle, a speed of the autonomous vehicle, a relative speed of the autonomous vehicle and another vehicle, or it can be a preset distance value. According to example embodiments, the safe distance can be updated by the autonomous vehicle (e.g., in a periodic manner). In some embodiments, visual indicators used by the autonomous vehicle (such as visual cue alerts for vehicles following the autonomous vehicle) may be based on sensor data of the autonomous vehicle. Visual indicators for a tailgating vehicle can be displayed on a rear part/surface of the autonomous vehicle, for example.

In the tailgating scenario, the autonomous vehicle can also display another sign indicating that the autonomous vehicle encourages the tailgating vehicle to pass the autonomous vehicle. For example, the AV may access data from its sensors indicating that there are no vehicles approaching the AV from a direction opposite from the AV. In some implementations, after a predefined time of opportunity for the tailgating vehicle to pass or to increase its distance from the autonomous vehicle has elapsed, if that vehicle continues to tailgate the autonomous vehicle, the autonomous vehicle can, for example, change lanes, or reduce or increase its speed within a proper speed limit to prevent a potential collision. In some implementations, the autonomous vehicle may display a sign for another vehicle only after that vehicle follows the autonomous vehicle at a distance less than a safe distance for a predetermined amount of time. In some example embodiments, the sign displayed by the autonomous vehicle to a tailgating vehicle can be a yellow light displayed on the back/rear side of the autonomous vehicle (or the back of the trailer that is connected to or is a part of the autonomous vehicle, back of a tractor, back of a passenger vehicle, etc.) indicating that the tailgating vehicle should increase its distance from the autonomous vehicle. That yellow light can turn green when the other vehicle increases its distance from the autonomous vehicle to a safe distance (predetermined or dynamically changing according to sensor data collected by the autonomous vehicle, for example). Providing the indicators to the vehicles following the autonomous vehicle may avoid rear-end collisions between the autonomous vehicles and other vehicles, for example.

In some example embodiments, when the autonomous vehicle is a tractor-trailer (e.g., a class 8 or other class vehicles), the autonomous vehicle can generate visual and/or audio warning signs when it performs a wide right turn to warn other vehicles following behind it in the same and/or other lanes of a road.

According to some example embodiments, when the autonomous vehicle is stopped at a traffic stop, it can indicate that it believes it is its turn to leave the stop by displaying a corresponding visual sign for other vehicles in the traffic stop area.

In some example embodiments, the autonomous vehicle can acknowledge that the autonomous vehicle understands directions given by a traffic controller at a road construction site or a police officer at an accident site by displaying corresponding visual signs and/or playing pre-recorded and/or ad hoc synthesized audio messages.

According to some example embodiments, an autonomous vehicle can display a sign or provide other means of visual indication that it is operating in the autonomous mode. Such information can be helpful for other vehicles and/or their drivers that share the road with the autonomous vehicle.

In certain example embodiments, the autonomous vehicle can use visual indicators in addition to the standard turn indicators when it is about to do an aggressive lane change (e.g., when the projected amount of time between the start of the standard turn indication and the actual turn is less than a predetermined threshold value).

The types of means or devices that can be used by an autonomous vehicle to provide visual signs, icons, indicators or cues to vehicles (both autonomous and human-operated) as well as other road users (e.g., pedestrians, construction workers, law enforcement persons, etc.) around the autonomous vehicle according to various embodiments include but are not limited to: one or more light sources (also referred to as lights), e.g., static or flashing; a group or an array or a series of light sources (e.g., light-emitting diodes (LEDs)) that can display a sequence of lights varying in position, intensity and/or color; one or more liquid crystal displays (LCDs) that can display both static and dynamic visual information (e.g., animations). Audio signals, cues, and indicators, of varying intensity, according to the disclosed technology can be generated by one or more speakers that can be positioned at any location on or in the autonomous vehicle. In some embodiments, if an autonomous vehicle provides warning signals to a vehicle that is following the autonomous vehicle too closely, and that vehicle does not increase its distance from the autonomous vehicle, the autonomous vehicle may increase the intensity or frequency of the warning signals or provide different warning signals. For example, the warning signals may become brighter in color or luminosity and/or become louder in audio. The autonomous vehicle can obtain information about its surrounding environment using various sensors and devices including but not limited to video cameras, LiDAR or RADAR (Radio Detection and Ranging) sensors, accelerometers, gyroscopes, inertial measurement units (IMUs), etc.

FIG. 1 shows a system 100 that includes an autonomous tractor 105. The autonomous tractor 105 includes a plurality of vehicle subsystems 140 and an in-vehicle control computer 150. The plurality of vehicle subsystems 140 includes vehicle drive subsystems 142, vehicle sensor subsystems 144, and vehicle control subsystems 146. An engine or motor, wheels and tires, a transmission, an electrical subsystem, and a power subsystem may be included in the vehicle drive subsystems 142. The engine of the autonomous truck may be an internal combustion engine, a fuel-cell powered electric engine, a battery powered electric engine, a hybrid engine, or any other type of engine capable of moving the wheels on which the autonomous tractor 105 moves. The autonomous tractor 105 can have multiple motors or actuators to drive the wheels of the vehicle. For example, the vehicle drive subsystems 142 can include two or more electrically driven motors. The transmission of the autonomous vehicle 105 may include a continuous variable transmission or a set number of gears that translate the power created by the engine of the autonomous vehicle 105 into a force that drives the wheels of the autonomous vehicle 105. The vehicle drive subsystems 142 may include an electrical system that monitors and controls the distribution of electrical current to components within the system, including pumps, fans, and actuators. The power subsystem of the vehicle drive subsystems 142 may include components that regulate the power source of the autonomous vehicle 105.

Vehicle sensor subsystems 144 can include sensors for general operation of the autonomous truck 105. The sensors for general operation of the autonomous vehicle may include cameras, a temperature sensor, an inertial sensor (IMU), a global positioning system, a light sensor, a LIDAR system, a radar system, and wireless communications.

The vehicle control subsystems 146 may be configured to control operation of the autonomous vehicle, or truck, 105 and its components. Accordingly, the vehicle control subsystems 146 may include various elements such as an engine power output subsystem, a brake unit, a navigation unit, a steering system, and an autonomous control unit. The engine power output may control the operation of the engine, including the torque produced or horsepower provided, as well as provide control of the gear selection of the transmission. The brake unit can include any combination of mechanisms configured to decelerate the autonomous vehicle 105. The brake unit can use friction to slow the wheels in a standard manner. The brake unit may include an anti-lock brake system (ABS) that can prevent the brakes from locking up when the brakes are applied. The navigation unit may be any system configured to determine a driving path or route for the autonomous vehicle 105. The navigation unit may additionally be configured to update the driving path dynamically while the autonomous vehicle 105 is in operation. In some embodiments, the navigation unit may be configured to incorporate data from a GPS device and one or more predetermined maps so as to determine the driving path for the autonomous vehicle 105. The steering system may represent any combination of mechanisms that may be operable to adjust the heading of the autonomous vehicle 105 in an autonomous mode or in a driver-controlled mode.

The autonomous control unit may represent a control system configured to identify, evaluate, and avoid or otherwise negotiate potential obstacles in the environment of the autonomous vehicle 105. In general, the autonomous control unit may be configured to control the autonomous vehicle 105 for operation without a driver or to provide driver assistance in controlling the autonomous vehicle 105. In some embodiments, the autonomous control unit may be configured to incorporate data from the GPS device, the RADAR, the LiDAR, the cameras, and/or other vehicle subsystems to determine the driving path or trajectory for the autonomous vehicle 105.

An in-vehicle control computer 150, which may be referred to as a vehicle control unit or VCU, can include, for example, any of: a vehicle subsystem interface 160, a driving operation module 168, one or more processors 170, a meta-perception module 165, a memory 175, an external signaling module 167, or a network communications subsystem 178. This in-vehicle control computer 150 may control many operations of the autonomous truck 105 in response to information available from the various vehicle subsystems 140. The one or more processors 170 execute the operations associated with the meta-perception module 165 that, for example, allow the system to determine confidence in perception data indicating a hazard, determine a confidence level of a regional map, and to analyze the behavior of agents of interest (also referred as targets) surrounding the autonomous vehicle 105. According to some example embodiments, an agent of interest or a target can be one of: another vehicle, a vehicle following the autonomous vehicle 105, a vehicle in a vicinity of the autonomous vehicle 105, a pedestrian, a construction zone, or a vehicle proximate to the autonomous vehicle 105. For example, the target may be within an intended maneuver zone around the autonomous vehicle. Data from vehicle sensor subsystems 144 may be provided to the meta-perception module 165 so that the course of action may be appropriately determined. Alternatively, or additionally, the meta-perception module 165 may determine the course of action in conjunction with another operational or control module, such as the driving operation module 168 or the external signaling module 167. According to some example embodiments, the external signaling module 167 can be configured to control signaling behaviors of the autonomous vehicle 105. According to some example embodiments, the signaling behaviors of the autonomous vehicle can be determined by the external signaling module 167 using, e.g., information provided by one or more sensors of the vehicle sensor subsystems 144. Example signaling behaviors of the autonomous vehicle 105 are described below.

The memory 175 may contain additional instructions as well, including instructions to transmit data to, receive data from, interact with, or control one or more of the vehicle drive subsystems 142, the vehicle sensor subsystems 144, or the vehicle control subsystems 146. The in-vehicle control computer (VCU) 150 may control the function of the autonomous vehicle 105 based on inputs received from various vehicle subsystems (e.g., the vehicle drive subsystems 142, the vehicle sensor subsystems 144, and the vehicle control subsystems 146). Additionally, the VCU 150 may send information to the vehicle control subsystems 146 to direct the trajectory, velocity, signaling behaviors, and the like, of the autonomous vehicle 105. The autonomous control vehicle control subsystems 146 may receive a course of action to be taken from one or more modules of the VCU 150 and consequently relay instructions to other subsystems to execute the course of action.

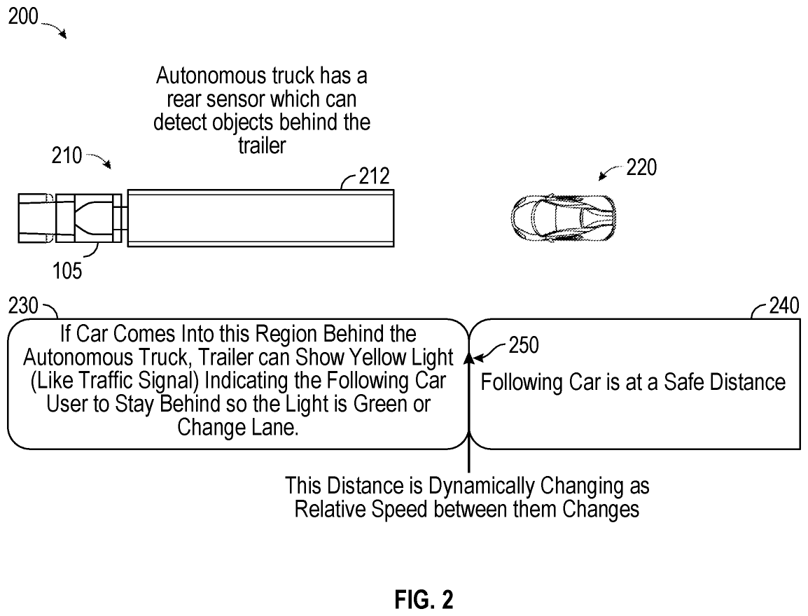

FIG. 2 shows an example traffic scenario 200, according to some example embodiments. An autonomous vehicle 210 (e.g., an autonomous truck), including an autonomous tractor 105 and a trailer 212, is equipped with a rear-view sensor (e.g., a camera and/or a LiDAR) which can be used to detect objects behind the autonomous vehicle 210, e.g., behind the autonomous tractor 105 or behind the trailer 212 when coupled to the autonomous tractor 105 (the sensor can be located on or in the autonomous tractor 105 or the trailer 212). As shown in FIG. 2, a vehicle 220 is moving behind the autonomous vehicle 210 (e.g., in the same lane as the autonomous vehicle 210). The following vehicle 220 can be, for example, an autonomous vehicle or a vehicle operated by a human driver. According to this example scenario, when the following vehicle 220 moves into the area 230 behind the autonomous vehicle 210, the autonomous vehicle 210 can display a visual signal (e.g., turn on a yellow light on the back of the autonomous tractor 105 and/or on the back of the trailer 212) for the following vehicle 220 indicating to the vehicle 220 or to its user/driver to either increase its distance from the autonomous vehicle 210 or to change lanes. The autonomous vehicle 210 can display a different sign (e.g., turn off the yellow light and turn on a green light on the back of the autonomous tractor 105 and/or on the back of its trailer 212) when the following vehicle 220 increases its distance from the vehicle autonomous 210 to a safe distance 250 (e.g., when the following vehicle 220 moves into the zone 240). The distance 250 can be dynamically adjusted by the autonomous vehicle 210 based, for example, on the speed at which the autonomous vehicle 210 is moving or based on a relative speed between the vehicles 210 and 220 or between the autonomous vehicle 210 and other vehicles.

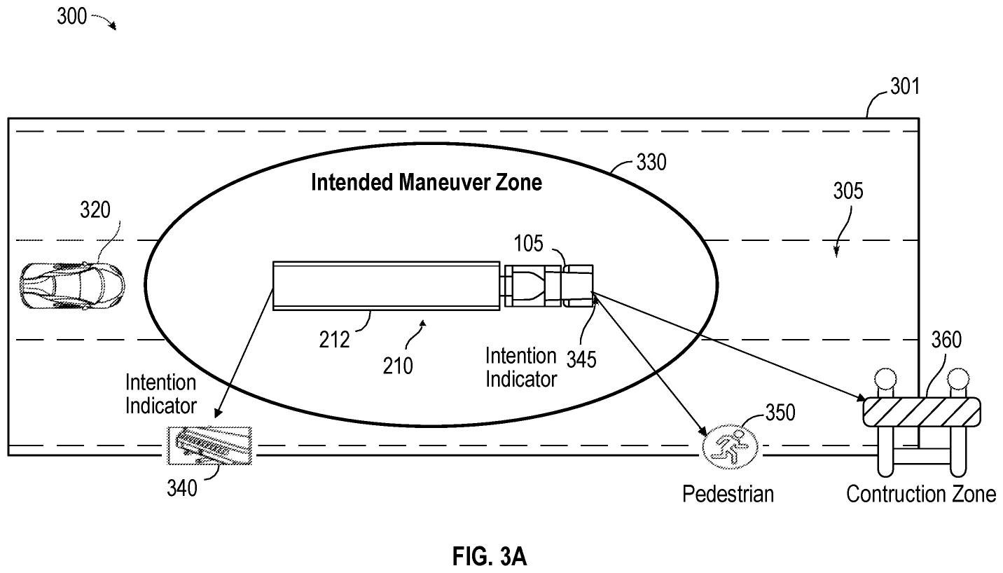

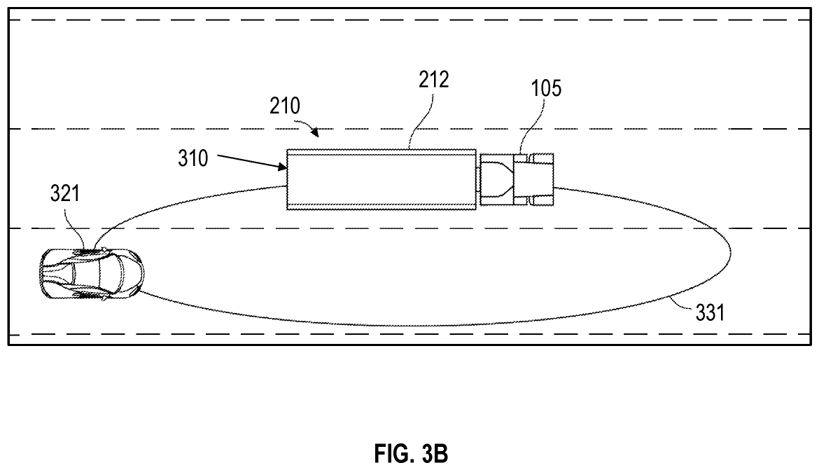

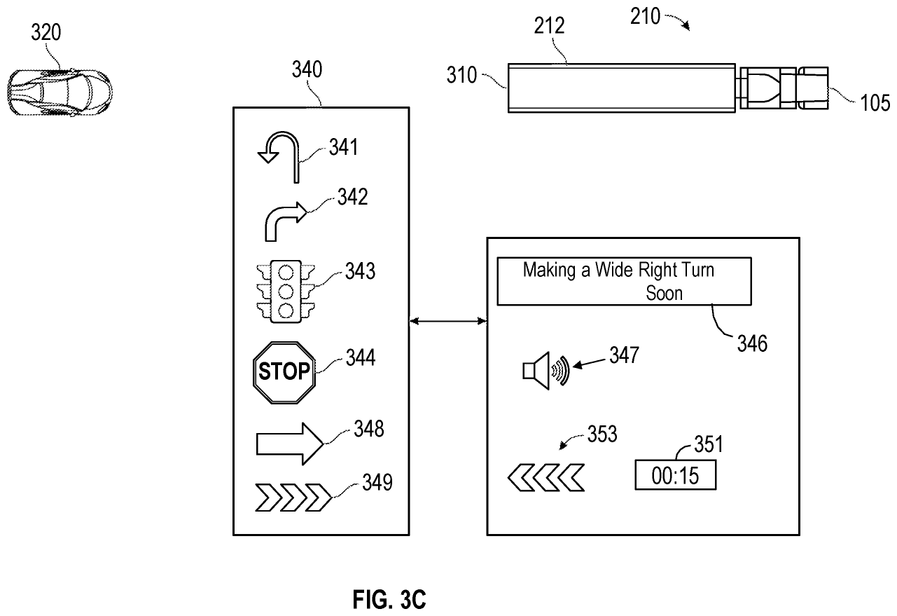

FIG. 3A shows another example traffic scenario 300, according to example embodiments. An autonomous vehicle 210 is moving in the lane 305 of the road 301. As shown in FIG. 3A, another vehicle 320 which can be, for example, operated in an autonomous mode or driven by a human driver, is moving behind the autonomous vehicle 210 in the same traffic lane 305. The intended maneuver zone 330 is a space around the autonomous vehicle 210 in which the autonomous vehicle 210 can move during an upcoming maneuver (e.g., lane change or acceleration or deceleration). The zone 330 is generally located inside the perception range of the autonomous vehicle 210 (e.g., within the perception range of one or more cameras or sensors of the autonomous vehicle 210). The zone 330 can vary in size, shape and/or position relative to the autonomous vehicle 210 based on the intended maneuver the autonomous vehicle 210 is planning to perform, as well as based on a current speed of the autonomous vehicle 210, its target speed, time allotted for the autonomous vehicle 210 to reach that target speed, a relative speed of the autonomous vehicle 210 and the other vehicle 320, a relative speed of the AV 210 and one or more other vehicles, a distance between the autonomous vehicle 210 and the vehicle 320, a distance between the autonomous vehicle 210 and another vehicle which can be moving in the same lane as the autonomous vehicle 210 (e.g., behind or in front of the autonomous vehicle 210) or in a different traffic lane, road conditions, weather conditions, and the like.

In some embodiments, the intended maneuver zone 330 may change in size and shape based on an intended maneuver of the AV 210. As shown in FIG. 3B, if the AV 210 intends to make a right turn, then the intended maneuver zone 330 may change into the intended maneuver zone 331. For example, the shape of the intended maneuver zone 331 may be an elongated oval, a rectangle, or the like, and its size may be smaller or larger than the intended maneuver zone 330. The location of intended maneuver zone 331 may be different than the location of the intended maneuver zone 330 such that the intended maneuver zone 331 may encompass the area to the right (e.g., from front to back) of the AV 210 where another vehicle 321 would be subject to the intended maneuver of the AV 210. In some examples, if the AV 210 increases its speed, then the size of the intended maneuver zone 331 may increase and its shape may change (e.g., into a rectangle) to encompass a larger area such that the intended maneuver zone can provide more time for the AV 210 to determine and execute an intended maneuver.

According to some example embodiments, the autonomous vehicle 210 includes an intention indicator 340, which may be located on the back surface 310 of the trailer 212 the vehicle 105 is towing, on the sides of the autonomous tractor 105, on the sides of the trailer 212, or on the back of the autonomous tractor 105 without a trailer 212. In some embodiments, when a trailer 212 is hooked up with an autonomous tractor 105, the intention indicator 340 on the back of the autonomous tractor 105 may be deactivated and the intention indicator 340 on the back surface 310 of the trailer 212 may be activated. When the trailer 212 is unhooked from the autonomous tractor 105, the intention indicator 340 on the back of the autonomous tractor 105 is reactivated.

As shown in FIG. 3C, the intention indicator 340 illustrates some example indicators including a U-turn 341, a right turn 342, approaching a traffic light 343, approaching a stop sign 344, and the like. The intention indicator 340 may also include textual 346 or audio signals (e.g., via a loudspeaker 347 on the surface 310) to further describe the upcoming intended maneuver of the AV 210. For example, the textual or audio signals may indicate that the AV will be making a wide turn (e.g., U-turn, right or left turn, etc.) In example embodiments, the autonomous vehicle 210 includes another intention indicator 345 (located, e.g., at the front of the AV 210 as shown in FIG. 3A). In some example embodiments, the intention indicator 340 is configured to generate a visual representation (e.g., a light, a time sequence of lights, an image, an icon, an animation) of an intended maneuver of the autonomous vehicle 210. In some example embodiments, the intention indicator 340 includes one or more light sources (e.g., LEDs, light bulbs or other light-emitting elements) or one or more image screens (e.g., LCDs). For example, the intention indicator 340 can emit green light to show that the vehicle 320 following the AV 210 is at a safe distance from the AV 210 or that the AV 210 determines that it is safe for the vehicle 320 to overtake it. In some example embodiments, the intention indicator 340 can emit yellow light to indicate to the vehicle 320 that the vehicle 320 needs to increase its distance from the autonomous vehicle 210. According to example embodiments, the intention indicator 340 can display a yellow arrow, which may be a static indicator 348 or an animated image 349, as a sequential arrow including a sequence of lights illuminating from one direction to another, e.g., left to right. Such an indicator may indicate to the vehicle 320 that it should be cautious because the AV 210 will perform a lane change soon, for example, from a current lane into a right lane. According to example embodiments, the intention indicator 340 can also display a countdown timer 351, next to a sequential arrow 353, showing the time left (e.g., 15 seconds) before the autonomous vehicle 210 starts its lane change maneuver. For example, the direction of the arrow 353 can indicate the direction of the future lane change, from a current lane into a left lane in 15 seconds, by the AV 210. In some example embodiments, the intention indicator 340 can display or generate a sign (e.g., an orange light) that alerts the following vehicle 320 that the AV 210 might perform a sudden brake. The AV 210 can anticipate that it might perform a sudden deceleration or braking based, for example, on its analysis of the environment including traffic conditions. In some embodiments, that analysis can be performed by the in-vehicle control computer 150 (as shown in FIG. 1) based on various sensor data from the vehicle sensor subsystems 144 (as shown in FIG. 1) of the AV 210. For example, data from the radar(s) in the vehicle sensor subsystems 144 may indicate that there are some objects (e.g., construction debris) in the road at 100 yards from the AV 310. This condition may cause the in-vehicle control computer 150 to issue one or more commands to the vehicle control subsystems 146 (as shown in FIG. 1) to cause the AV 310, for example, to suddenly apply its brakes or make a sudden lane change. The intention indicator 340 can be also used in certain example embodiments to show an intention of the autonomous vehicle 210 to human drivers, pedestrians (e.g., 350 in FIG. 3A), construction workers at a construction site or within a construction zone (e.g., 360 in FIG. 3A), as well as to other vehicles that share the same road 301 with the autonomous vehicle 210. In some example embodiments, the intention indicator 340 can be also used as a secondary communication tool between the AV 210 and other autonomous or connected vehicles. In some embodiments, in addition to having vehicle-to-vehicle communications (e.g., via one or more wireless communications) with other AVs or with connected vehicles (e.g., a vehicle driven by a human and having connection(s) to AV(s) in close proximity), the AV 310 may use the intention indicator 340 to signal its intentions to the other AVs or the connected vehicles. For example, in addition to utilizing its network communications subsystem 178 to communicate its intended maneuver (e.g., a wide left turn) to other AVs and connected vehicles, the AV 310 may also activate the intention indicator 342 to alert the other AVs and connected vehicles that the AV 310 will be making a right turn. In some embodiments, the AV 310 may utilize one or more sensors (e.g., cameras) in its vehicle sensor subsystems 144 of FIG. 1, to detect the intention indicators of other AVs proximate to the AV 310. For example, a camera on the AV 310 may detect a turn signal activated on another vehicle or on an AV near the AV 310. The detected signal may be transmitted to the in-vehicle control computer 150 of FIG. 1, which may utilize one or more of its modules (e.g., processors) to interpret that the turn signal indicates a right turn, left turn, or U-turn.

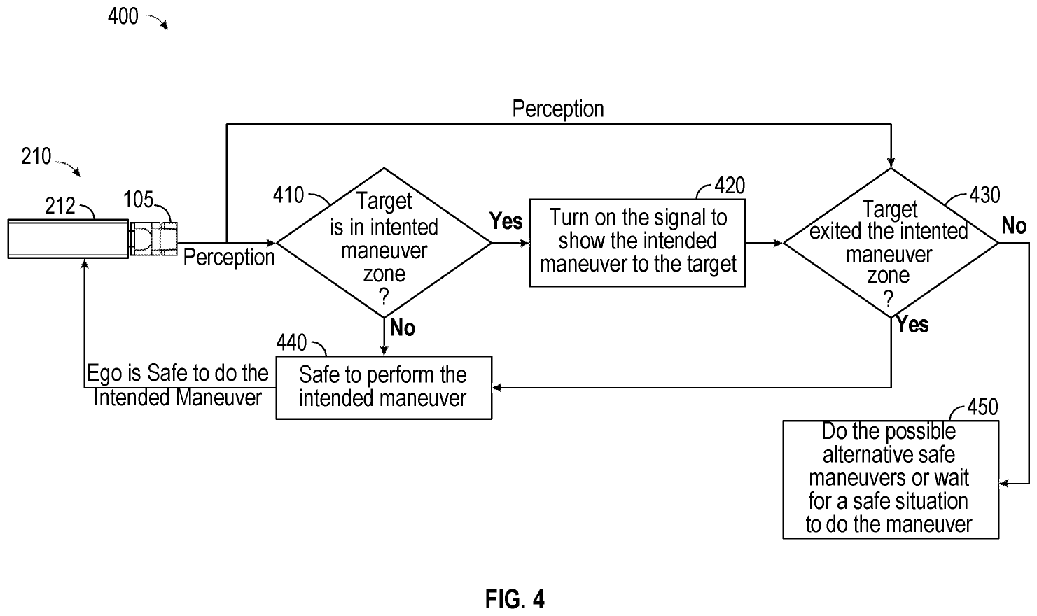

FIG. 4 shows a flowchart of an example method 400, according to example embodiments. The autonomous vehicle 210 shown in FIG. 4 may use data from its vehicle sensor subsystems 144 (e.g., various cameras and sensors such as LiDARs or RADARs) to sense or perceive its surrounding environment including but not limited to traffic conditions, road conditions, weather conditions, etc. The road conditions can include, for example, condition of the pavement or that of an unpaved road, locations of potholes, objects on the road, etc. In some examples, based on the road conditions, the AV 210 may reduce its speed, change lanes, or stop. The AV 210 may also take other actions, such as pulling onto the shoulder and stop, in order to negotiate the road conditions (e.g., a boulder in the road). In some embodiments, a camera on the AV 210 may detect that the road surface is granular (e.g., unpaved), or that the surfaces of two adjacent lanes are uneven (e.g., one lane is paved, and an adjacent lane is yet to be paved). In one embodiment, a vibration sensor on the AV 210 may detect vibrations from the road surface (e.g., propagated through the tires/wheels to the vibrations sensor), which may indicate that the road surface is gravel instead of being a paved surface. The traffic conditions can include, for example, distances from the autonomous vehicle 210 to the surrounding (close and/or distant) vehicles, pedestrians, movable objects, stationary objects (e.g., buildings, road signs, etc.), etc., as well as positions, speeds or velocities of those vehicles, pedestrians and objects. At block 410 of the flowchart 400, the method includes performing, by the autonomous vehicle 210, a determination as to whether a target (e.g., another vehicle or a pedestrian) is in an intended maneuver zone around the autonomous vehicle 210. An intended maneuver zone (e.g., 330 as shown in FIG. 3A) is a space around the AV 210 in which the AV 210 can move during an upcoming maneuver (e.g., a wide turn, a lane change, an acceleration, a braking, etc.) The intended maneuver zone 330 may change as the AV 210 plans one or more intended maneuvers. For example, during a planned wide right turn by the AV 210, the intended maneuver zone 330 may be an area to the right of and parallel (e.g., from right front to right rear) to the AV 210. Or, during a backing-up maneuver, the intended maneuver zone may be the entire area to the rear and both sides of the AV 210. In some embodiments, the AV 210 may detect (e.g., by its cameras, radars, etc.) a gravel road, wet road, icy road, and the like road conditions causing an intended maneuver zone 330 to extend farther to the back and to the sides of the AV 210. In response to the road conditions, the AV 210 may activate the intention indicator signals 340, for example, on a screen including texts displaying a message such as “stay 100 meters away due to gravel on the road,” or sounds that suggest the same or a different message, a color (e.g., red) that flashes on the screen, or the like signals. At block 420, the method 400 includes generating (or activating), by the autonomous vehicle 210, an intended maneuver signal to show the intended maneuver to the target (e.g., to show a graphical (static or animated) representation (e.g., an icon, an image, a symbol, a sequence of images, a cartoon, etc.) of the intended maneuver) in response to determining that the target is within the intended maneuver zone of the autonomous vehicle 210 at block 410 of the method 400. For example, the AV 210 may activate one or more signals to indicate to other vehicles, which may be following the AV 210 in the same lane or in an adjacent lane, that the AV 210 will be making a wide turn (e.g., right, left, U-turn). At block 430, the method 400 includes determining, by the autonomous vehicle 210 and based on perception information acquired by the autonomous vehicle 210, whether the target left the intended maneuver zone around the autonomous vehicle 210. At block 440, the method 400 includes determining, by the autonomous vehicle 210, that it is safe to perform the intended maneuver in response to determining, by the autonomous vehicle 210, that the target is not in the intended maneuver zone at block 410 of the method 400 or in response to determining that the target has left the intended maneuver zone at block 430 of the method 400. For example, for a safe maneuver, the AV 210 may utilize data from its vehicle sensor subsystems 144 (e.g., cameras, radars, etc.) of FIG. 1, to determine that there are no objects (e.g., other vehicles, persons, construction equipment, etc.) within the intended maneuver zone, 330 of FIG. 3A, that the AV 210 may collide with causing injury or a sudden, unnecessary displacement of the objects from their current locations. In example embodiments, the method 400 further includes performing, by the autonomous vehicle 210, the intended maneuver. The block 450 of the method 400 includes performing, by the autonomous vehicle 210, an alternative safe maneuver or waiting for a safe situation to perform the intended maneuver in response to determining that the target did not leave the intended maneuver zone at block 430 of the method 400. For example, the AV 210 may determine, from its radar in the vehicle sensor subsystems 144, that there is road debris ahead in its lane and that it should change into an adjacent right lane. However, if there is another vehicle travelling in the adjacent right lane, then the AV 210 may change its lane into an adjacent left lane if there are no other targets (e.g., another vehicle) in the left lane. Otherwise, to safely avoid the road debris, the AV 210 can also slowdown in its current travelling lane, allow the vehicle in the adjacent right line to pass the AV 210, and then change its lane into the adjacent right lane. In some example embodiments, the intended maneuver signal is one of: a light, a time sequence of lights, an image, an icon, an animation. According to example embodiments, generating the intended maneuver signal is performed using one of: a light source and/or an image screen.

Various technical solutions that may be implemented by some embodiments include:

A method (e.g., method 400) of operating an autonomous vehicle, including determining, by the autonomous vehicle, whether a target is in an intended maneuver zone around the autonomous vehicle; generating, by the autonomous vehicle, a signal in response to determining that the target is within the intended maneuver zone around the autonomous vehicle; determining, by the autonomous vehicle and based on perception information acquired by the autonomous vehicle, whether the target has left the intended maneuver zone around the autonomous vehicle; and determining, by the autonomous vehicle, that it is safe to perform the intended maneuver in response to determining, by the autonomous vehicle, that the target is not in the intended maneuver zone or in response to determining, by the autonomous vehicle, that the target has left the intended maneuver zone.

The method of operating an autonomous vehicle further includes performing, by the autonomous vehicle, the intended maneuver.

The method of operating an autonomous vehicle further includes performing, by the autonomous vehicle, an alternative maneuver or delaying the intended maneuver in response to determining that the target is within the intended maneuver zone.

In the method of operating an autonomous vehicle the signal is generated, by the autonomous vehicle, via a light source and/or an image screen.

In the method of operating an autonomous vehicle the signal is an intended maneuver signal including a time sequence of lights, an image, an icon, and/or an animation.

In the method of operating an autonomous vehicle the target includes a vehicle following the autonomous vehicle, a pedestrian, a construction zone, and/or a vehicle in a vicinity of the autonomous vehicle.

In the method of operating an autonomous vehicle the signal includes one or more warning signals generated, by the autonomous vehicle, in response to determining, by the autonomous vehicle, that a distance between a vehicle following the autonomous vehicle and the autonomous vehicle is below a threshold value.

In the method of operating an autonomous vehicle the threshold value is based on a predetermined value or based on a value determined, by the autonomous vehicle, based on traffic conditions, road conditions, speed of the vehicle following the autonomous vehicle relative to the speed of the autonomous vehicle, and/or a weight of the autonomous vehicle including a weight of goods being transported by the autonomous vehicle.

In the method of operating an autonomous vehicle the one or more warning signals include one or more variable-intensity visual and/or audio signals, and wherein the one or more variable-intensity visual signals are presented, by the autonomous vehicle, at one or more external locations on the autonomous vehicle, and/or the one or more variable-intensity audio signals are presented, by the autonomous vehicle, via one or more audio devices in or on the autonomous vehicle.

A system for autonomous driving operation, including an autonomous vehicle that includes a plurality of subsystems configured to determine, by at least one of the plurality of subsystems, whether a target is in an intended maneuver zone around the autonomous vehicle; generate, by at least one of the plurality of subsystems, a signal in response to determining that the target is within the intended maneuver zone around the autonomous vehicle; determine, by at least one of the plurality of subsystems, perception information indicating whether the target has left the intended maneuver zone around the autonomous vehicle; and determine, by at least one of the plurality of subsystems, that it is safe for the autonomous vehicle to perform the intended maneuver in response to determining, by at least one of the plurality of subsystems, that the target is not in the intended maneuver zone or in response to determining, by at least one of the plurality of subsystems, that the target has left the intended maneuver zone.

In the system for autonomous driving operation at least one of the plurality of subsystems causes the autonomous vehicle to perform the intended maneuver.

In the system for autonomous driving operation at least one of the plurality of subsystems causes the autonomous vehicle to perform an alternative maneuver or delay the intended maneuver in response to determining that the target is within the intended maneuver zone.

In the system for autonomous driving operation the signal is generated, by at least one of the plurality of subsystems, via a light source and/or an image screen.

In the system for autonomous driving operation the signal is an intended maneuver signal including a time sequence of lights, an image, an icon, and/or an animation.

In the system for autonomous driving operation the target includes a vehicle following the autonomous vehicle, a pedestrian, a construction zone, and/or a vehicle in a vicinity of the autonomous vehicle.

In the system for autonomous driving operation the signal includes one or more warning signals generated, by at least one of the plurality of subsystems, in response to determining, by at least one of the plurality of subsystems, that a distance between a vehicle following the autonomous vehicle and the autonomous vehicle is below a threshold value.

In the system for autonomous driving operation the threshold value is based on a predetermined value or based on a value determined, by at least one of the plurality of subsystems, based on traffic conditions, road conditions, speed of the vehicle following the autonomous vehicle relative to the speed of the autonomous vehicle, and/or a weight of the autonomous vehicle including a weight of goods being transported by the autonomous vehicle.

In the system for autonomous driving operation the one or more warning signals include one or more variable-intensity visual and/or audio signals, and wherein the one or more variable-intensity visual signals are presented, by at least one of the plurality of subsystems, at one or more external locations on the autonomous vehicle, and/or the one or more variable-intensity audio signals are presented, by at least one of the plurality of subsystems, via one or more audio devices in or on the autonomous vehicle.

A non-transitory machine-useable storage medium embodying instructions which, when executed by a machine, cause the machine to determine, by an autonomous vehicle, whether a target is in an intended maneuver zone around the autonomous vehicle; generate, by the autonomous vehicle, a signal in response to determining that the target is within the intended maneuver zone around the autonomous vehicle; determine, by the autonomous vehicle and based on perception information acquired by the autonomous vehicle, whether the target has left the intended maneuver zone around the autonomous vehicle; and determine, by the autonomous vehicle, that it is safe to perform the intended maneuver in response to determining, by the autonomous vehicle, that the target is not in the intended maneuver zone or in response to determining, by the autonomous vehicle, that the target has left the intended maneuver zone.

In the non-transitory machine-useable storage medium the signal includes one or more warning signals generated, by the autonomous vehicle, in response to determining, by the autonomous vehicle, that a distance between a vehicle following the autonomous vehicle and the autonomous vehicle is below a threshold value.

Implementations of the subject matter and the functional operations described in this document can be implemented in various systems, semiconductor devices, ultrasonic devices, digital electronic circuitry, or in computer software, firmware, or hardware, including the structures disclosed in this specification and their structural equivalents, or in combinations of one or more of them. Implementations of aspects of the subject matter described in this specification can be implemented as one or more computer program products, e.g., one or more modules of computer program instructions encoded on a tangible and non-transitory computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing unit” or “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random-access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of nonvolatile memory, media and memory devices, including by way of example semiconductor memory devices, e.g., EPROM, EEPROM, and flash memory devices. The processor and the memory can be supplemented by, or incorporated in, special purpose logic circuitry.

In this disclosure, LiDAR and LIDAR are used to refer to light detection and ranging devices and methods, and alternatively, or additionally, laser detection and ranging devices and methods. The use of these acronyms does not imply limitation of the described devices, systems, or methods to the use of one over the other.

While this document contains many specifics, these should not be construed as limitations on the scope of any invention or of what may be claimed, but rather as descriptions of features that may be specific to particular embodiments of particular inventions. Certain features that are described in this document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in this document should not be understood as requiring such separation in all embodiments.

Only some implementations and examples are described, and other implementations, enhancements and variations can be made based on what is described and illustrated in this document.

What is claimed is:

1. A method of operating an autonomous vehicle, comprising:
determining, by the autonomous vehicle, whether a target is in an intended maneuver zone around the autonomous vehicle;
generating, by the autonomous vehicle, a signal in response to determining that the target is within the intended maneuver zone around the autonomous vehicle;
determining, by the autonomous vehicle and based on perception information acquired by the autonomous vehicle, whether the target has left the intended maneuver zone around the autonomous vehicle; and
determining, by the autonomous vehicle, that it is safe to perform the intended maneuver in response to determining, by the autonomous vehicle, that the target is not in the intended maneuver zone or in response to determining, by the autonomous vehicle, that the target has left the intended maneuver zone.

2. The method of operating an autonomous vehicle according to claim 1, further comprising:
performing, by the autonomous vehicle, the intended maneuver.

3. The method of operating an autonomous vehicle according to claim 1, further comprising:
performing, by the autonomous vehicle, an alternative maneuver or delaying the intended maneuver in response to determining that the target is within the intended maneuver zone.

4. The method of operating an autonomous vehicle according to claim 1, wherein the signal is generated, by the autonomous vehicle, via a light source and/or an image screen.

5. The method of operating an autonomous vehicle according to claim 4, wherein the signal is an intended maneuver signal including a time sequence of lights, an image, an icon, and/or an animation.

6. The method of operating an autonomous vehicle according to claim 1, wherein the target includes a vehicle following the autonomous vehicle, a pedestrian, a construction zone, and/or a vehicle in a vicinity of the autonomous vehicle.

7. The method of operating an autonomous vehicle according to claim 1, wherein the signal includes one or more warning signals generated, by the autonomous vehicle, in response to determining, by the autonomous vehicle, that a distance between a vehicle following the autonomous vehicle and the autonomous vehicle is below a threshold value.

8. The method of operating an autonomous vehicle according to claim 7, wherein the threshold value is based on a predetermined value or based on a value determined, by the autonomous vehicle, based on traffic conditions, road conditions, speed of the vehicle following the autonomous vehicle relative to the speed of the autonomous vehicle, and/or a weight of the autonomous vehicle including a weight of goods being transported by the autonomous vehicle.

9. The method of operating an autonomous vehicle according to claim 7, wherein the one or more warning signals include one or more variable-intensity visual and/or audio signals, and wherein the one or more variable-intensity visual signals are presented, by the autonomous vehicle, at one or more external locations on the autonomous vehicle, and/or the one or more variable-intensity audio signals are presented, by the autonomous vehicle, via one or more audio devices in or on the autonomous vehicle.

10. A system for autonomous driving operation, comprising:
an autonomous vehicle comprising a plurality of subsystems configured to:
determine, by at least one of the plurality of subsystems, whether a target is in an intended maneuver zone around the autonomous vehicle;
generate, by at least one of the plurality of subsystems, a signal in response to determining that the target is within the intended maneuver zone around the autonomous vehicle;
determine, by at least one of the plurality of subsystems, perception information indicating whether the target has left the intended maneuver zone around the autonomous vehicle; and
determine, by at least one of the plurality of subsystems, that it is safe for the autonomous vehicle to perform the intended maneuver in response to determining, by at least one of the plurality of subsystems, that the target is not in the intended maneuver zone or in response to determining, by at least one of the plurality of subsystems, that the target has left the intended maneuver zone.

11. The system for autonomous driving operation according to claim 10, wherein at least one of the plurality of subsystems causes the autonomous vehicle to perform the intended maneuver.

12. The system for autonomous driving operation according to claim 10, wherein at least one of the plurality of subsystems causes the autonomous vehicle to perform an alternative maneuver or delay the intended maneuver in response to determining that the target is within the intended maneuver zone.

13. The system for autonomous driving operation according to claim 10, wherein the signal is generated, by at least one of the plurality of subsystems, via a light source and/or an image screen.

14. The system for autonomous driving operation according to claim 10, wherein the signal is an intended maneuver signal including a time sequence of lights, an image, an icon, and/or an animation.

15. The system for autonomous driving operation according to claim 10, wherein the target includes a vehicle following the autonomous vehicle, a pedestrian, a construction zone, and/or a vehicle in a vicinity of the autonomous vehicle.

16. The system for autonomous driving operation according to claim 10, wherein the signal includes one or more warning signals generated, by at least one of the plurality of subsystems, in response to determining, by at least one of the plurality of subsystems, that a distance between a vehicle following the autonomous vehicle and the autonomous vehicle is below a threshold value.

17. The system for autonomous driving operation according to claim 16, wherein the threshold value is based on a predetermined value or based on a value determined, by at least one of the plurality of subsystems, based on traffic conditions, road conditions, speed of the vehicle following the autonomous vehicle relative to the speed of the autonomous vehicle, and/or a weight of the autonomous vehicle including a weight of goods being transported by the autonomous vehicle.

18. The system for autonomous driving operation according to claim 16, wherein the one or more warning signals include one or more variable-intensity visual and/or audio signals, and wherein the one or more variable-intensity visual signals are presented, by at least one of the plurality of subsystems, at one or more external locations on the autonomous vehicle, and/or the one or more variable-intensity audio signals are presented, by at least one of the plurality of subsystems, via one or more audio devices in or on the autonomous vehicle.

19. A non-transitory machine-useable storage medium embodying instructions which, when executed by a machine, cause the machine to:
determine, by an autonomous vehicle, whether a target is in an intended maneuver zone around the autonomous vehicle;
generate, by the autonomous vehicle, a signal in response to determining that the target is within the intended maneuver zone around the autonomous vehicle;
determine, by the autonomous vehicle and based on perception information acquired by the autonomous vehicle, whether the target has left the intended maneuver zone around the autonomous vehicle; and
determine, by the autonomous vehicle, that it is safe to perform the intended maneuver in response to determining, by the autonomous vehicle, that the target is not in the intended maneuver zone or in response to determining, by the autonomous vehicle, that the target has left the intended maneuver zone.

20. The non-transitory machine-useable storage medium according to claim 19, wherein the signal includes one or more warning signals generated, by the autonomous vehicle, in response to determining, by the autonomous vehicle, that a distance between a vehicle following the autonomous vehicle and the autonomous vehicle is below a threshold value.
